(19) United States
(12) Patent Application Publication
(10) Pub. No.: US 2026/0298744 A1
(43) Pub. Date: Oct. 1, 2026

(54) STRAIN GAUGE PRESSURE SENSOR WITH IMPROVED OUTPUT

(71) Applicant: ROSEMOUNT INC, Shakopee, MN (US)

(72) Inventors: David M STREI, Waconia, MN (US); Nicholas E MEYER, Excelsior, MN (US); David J HILLMAN, Prescott, WI (US)

(21) Appl. No.: 19/092,410

(22) Filed: Mar. 27, 2025

(51) Int. Cl. G01L 9/00

(52) U.S. Cl. CPC G01L 9/0051

(57) ABSTRACT

A pressure sensor includes a crystalline substrate and a deflectable diaphragm formed in the crystalline substrate. At least five strain gauges are attached to the deflectable diaphragm with each strain gauge having an electrical characteristic that varies with diaphragm deflection.

### BACKGROUND

In some process control system installations, a pressure transmitter is used to monitor the pressure of a process fluid in a conduit or storage tank. The pressure transmitter includes circuitry that measures or otherwise obtains an electrical indication of a pressure sensor that is hydraulically coupled to the remote location of the pressure being monitored. The magnitude of the pressure sensor signal represents the pressure of the process fluid.

In many pressure sensors, a flexible diaphragm moves relative to a base in response to pressure applied to the top of the diaphragm. The diaphragm typically includes one or more electrical structures, such as electrodes or traces, that have an electrical characteristic, such as resistance or capacitance, that changes with the deflection of the sensing diaphragm. Diaphragms that provide repeatable monotonic movement in response to applied pressures are preferred. As a result, crystalline diaphragms, such as those made from crystalline silicon have been widely adopted since they provide monotonic movement in response to applied pressures and are generally free of hysteretic effects.

A silicon pressure sensor typically includes one or more strain gauges mounted on a deflectable diaphragm. As the diaphragm deflects in response to applied pressure, the strain gauge provides an electrical indication of the deflection. The ration of electrical change (e.g. resistance on the strain gauge(s)) to applied pressure is known as the gage factor. Increasing the gage factor means that for a given applied pressure on the deflectable diaphragm, the electrical output or response will be increased.

### SUMMARY

A pressure sensor includes a crystalline substrate and a deflectable diaphragm formed in the crystalline substrate. At least five strain gauges are attached to the deflectable diaphragm with each strain gauge having an electrical characteristic that varies with diaphragm deflection.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a diagrammatic view of a known pressure sensor manufactured from silicon and having a square diaphragm.

FIG. 2 is a diagrammatic view of a square silicon pressure sensor in accordance with an embodiment of the present invention.

FIG. 3A is a circuit diagram incorporating the pressure sensor shown in FIG. 1.

FIG. 3B is a circuit diagram incorporating the pressure sensor shown in FIG. 2.

FIG. 4 is a chart of gage factor vs applied pressure contrasting a known pressure sensor with a pressure sensor in accordance with an embodiment of the present invention.

FIG. 5A is a diagrammatic view of a square silicon pressure sensor substrate in accordance with another embodiment of the present invention.

FIG. 5B is a diagrammatic view of a cover that is attached to a square silicon pressure sensor substrate in accordance with an embodiment of the present invention.

FIG. 5C is a cross-sectional view of a silicon pressure sensor in accordance with an embodiment of the present invention.

FIG. 6 is a diagrammatic view of a multi-sensor system in accordance with an embodiment of the present invention.

FIG. 7 is a block diagram of a strain gauge-based pressure sensing system in accordance with an embodiment of the present invention.

FIG. 8 is a diagrammatic view of a pressure sensing system with which embodiments described herein are particularly useful.

### DETAILED DESCRIPTION OF ILLUSTRATIVE EMBODIMENTS

Microelectromechanical System (MEMS) pressure sensors manufactured from crystalline materials, such as silicon, typically utilize strain gages disposed thereon to measure the deflection of a square diaphragm in response to applied pressure. One difficulty for pressure sensors that utilize square diaphragms is that the locations of maximum and minimum strain (i.e., the ideal locations for strain gauges) are points. However, strain gauges generally cover an area under strain and are not well-suited for measurements of strain occurring at a point. While embodiments of the present invention will be described with respect to a particular material, silicon, it is expressly contemplated that embodiments describe herein are applicable to other crystalline materials including, without limitation, alumina, sapphire, and glass.

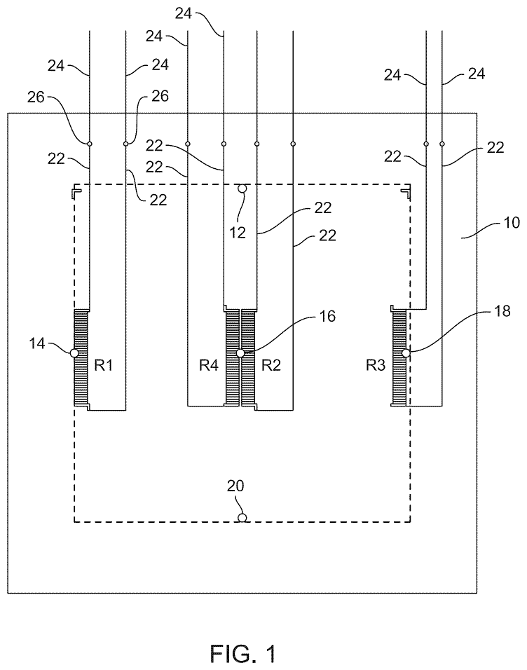

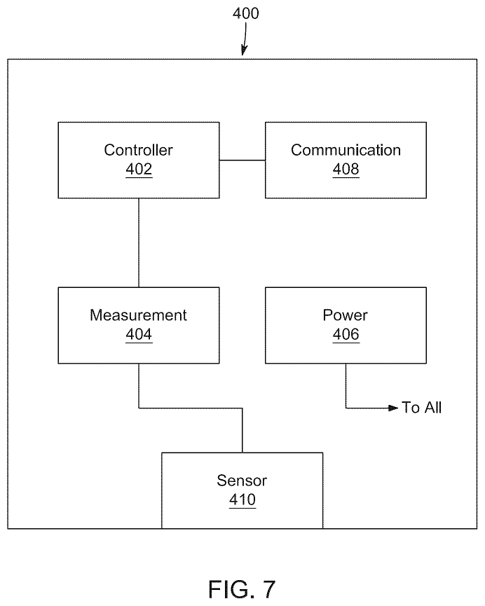

FIG. 1 is a diagrammatic view of a known pressure sensor manufactured from silicon and having a square diaphragm. FIG. 1 shows the strain gages (labeled R1-R4) on a typical square silicon pressure sensor 10. Each strain gauge R1-R4 is electrically coupled to traces 22 that are then coupled to conductors 24 at connection pad/regions 26. Conductors 24 are operably coupled to suitable measurement circuitry (such as measurement circuitry 404, shown in FIG. 7) to enable the measurement of the resistance of each strain gauge R1-R4. Those skilled in the art will recognize that some of the traces may be combined electrically in order to reduce the number of pad/regions 26 and conductors 24. As shown, the majority of each strain gauge R1-R4 is not located on the ideal point locations 12, 14, 16, 18, and 20. This limits the sensitivity of pressure sensor 10. One solution to this issue is to reduce the line width of the strain gage resistors. This keeps the overall resistance of the strain gage the same but reduces the size so it can more closely cover the area of max/min strain. A trade-off with this approach is the location of the strain gage relative to the points 12, 14, 16, 18, and 20 of max/min strain must be more accurate to match the strain gage to the points of max/min strain and the sensor is more sensitive to variations in line width of the gages.

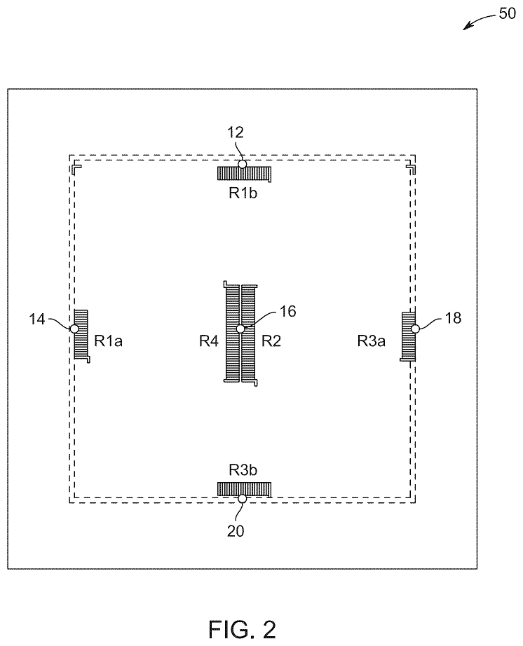

FIG. 2 is a diagrammatic view of a square silicon pressure sensor in accordance with an embodiment of the present invention. For purposes of illustration, traces and conductors are not shown in FIG. 2. As can be seen, pressure sensor 50 includes six individual strain gauges R1a, R1b, R2, R3a, R3b, and R4. R1a is positioned proximate strain maximum location 14; R1b is positioned proximate strain maximum location 12; R2 is positioned proximate strain maximum location 16; R3a is positioned proximate strain maximum location 18; R3b is positioned proximate strain maximum location 20; and R4 is positioned proximate R2 and strain maximum location 16. Strain maximum locations 12, 14, 18, and 20 are locations of maximum tensile strain, while location 16 is a location of maximum compressive strain. The output of the sensor (often referred to as gage factor) can be increased with the same mechanical design of the sensor simply by dividing the outside strain gages in half and locating each half of the gage on adjacent sides of the diaphragm as shown in FIG. 2.

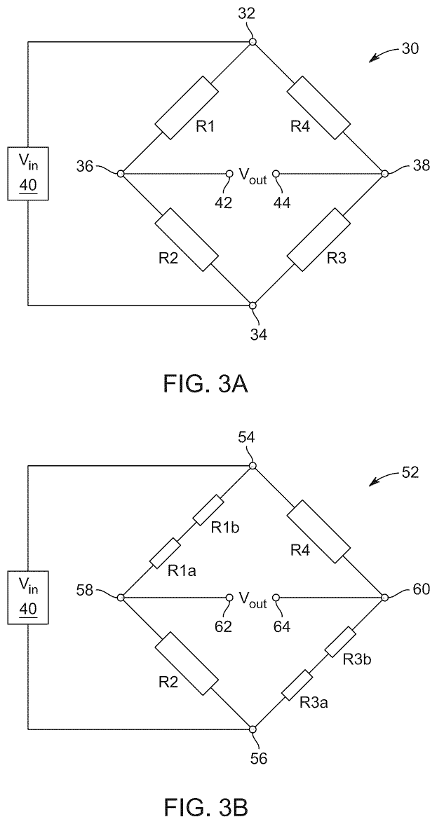

FIG. 3A is a circuit diagram incorporating the pressure sensor shown in FIG. 1. R1-R4 are arranged in a Wheatstone bridge with R1 and R4 coupled to input terminal 32, while R2 and R3 are coupled to input terminal 34. R1, R2, and output terminal 42 are coupled together at node 36, while R3, R4, and output terminal 44 are coupled together at node 38. Voltage source 40 supplies an input voltage Vᵢₙ at input terminals 32 and 34, and measurement circuitry, such as measurement circuitry 404 (shown in FIG. 7) measures the resultant output voltage. The Wheatstone bridge circuit is particularly suited for detecting small differences in the resistances of R1-R4. If R1=R2=R3=R4 when no pressure is applied to the deflectable diaphragm, then the Wheatstone Bridge is considered a balanced circuit and the output voltage at zero pressure is zero volts. However, as the diaphragm deflects, R1-R4 are no longer equal and a voltage will appear at terminals 42, 44, which voltage is related to the strain at locations 14, 16, and 18 in FIG. 1, and thus related to the applied pressure on the pressure sensor. Note, while various circuit connections can be done simply using conductors 24, some connections of the Wheatstone bridge can be done via additional traces 22 on the pressure sensor.

FIG. 3B is a circuit diagram 52 incorporating pressure sensor 50 shown in FIG. 2. The circuit design, like that shown in FIG. 3A, is a basic Wheatstone bridge. As shown, R1a and R1b are connected in series and coupled between input terminal 54 and circuit node 58. R2 is coupled between input terminal 56 and circuit node 58. R3a and R3b are connected in series between input terminal 56 and circuit node 60. Finally, R4 is connected between input terminal 54 and circuit node 60. Output terminals 62, 64 are couped to circuit nodes 58, 60, respectively. Voltage source 40 supplies an input voltage Vᵢₙ at input terminals 54 and 56, and measurement circuitry, such as measurement circuitry 404 (shown in FIG. 7) measures the resultant output voltage at terminals 62, 64. Preferably, in the circuit of FIG. 3B, when no pressure is applied, R1a=R1b=R2/2=R3a=R3b=R4/2. For the compressive strain gauges located in the center of the deflectable diaphragm, the output signal can only be increased by making the strain gauges smaller and modifying the line width to keep the baseline resistance the same.

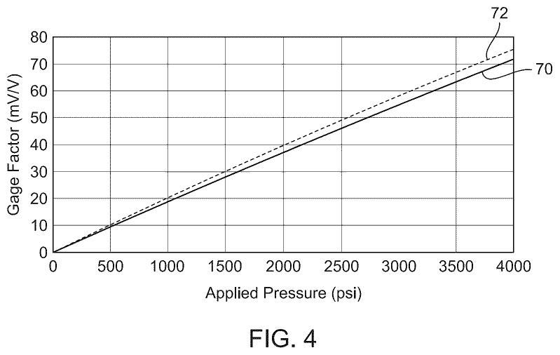

FIG. 4 is a chart of gage factor vs applied pressure contrasting a known pressure sensor with a pressure sensor in accordance with an embodiment of the present invention. FIG. 4 illustrates an example of the improved performance in (gage factor, mV/V) as a function of applied pressure in pounds per square inch (psi) for a known sensor (line 70) versus a sensor in accordance with an embodiment of the present invention (line 72). The known sensor typically is a four-strain gage sensor design (shown in FIG. 1) with two tensile strain gages and two compressive strain gages. The improved sensor (line 72) employs a six-gage sensor design (shown in FIG. 2) in accordance with an embodiment of the present invention and has two compressive strain gages and four tensile strain gages. As can be seen, both sensors have a gage factor that is linear as pressure increases. However, while the known sensor 70 reaches a gage factor of slightly over 70 mV/V at 4000 psi, the improves sensor 72 reaches a gage factor of 75 mV/V at 4000 psi, which is a significant improvement of over 7%.

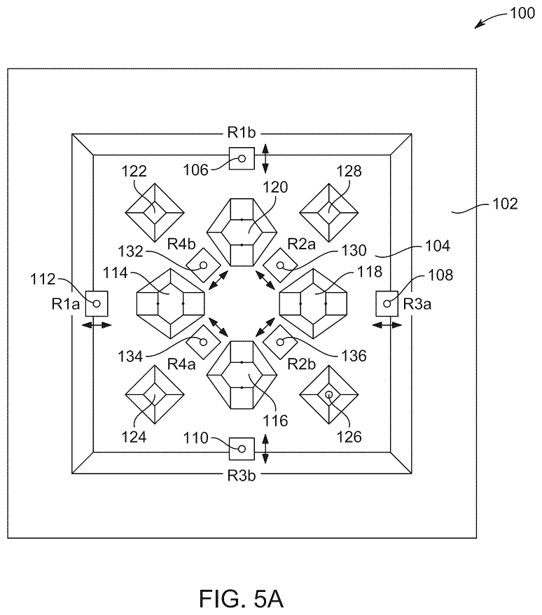

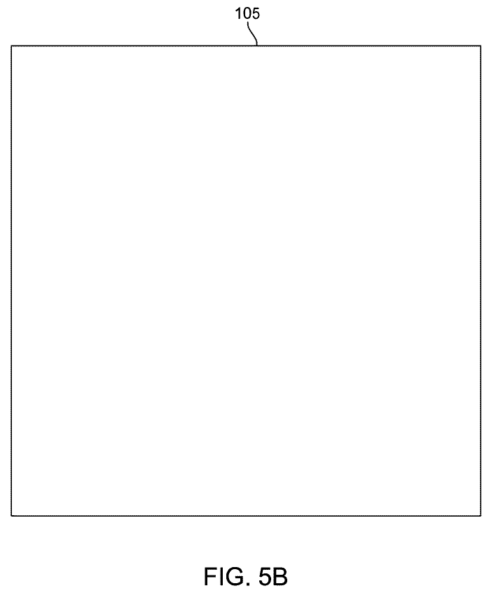

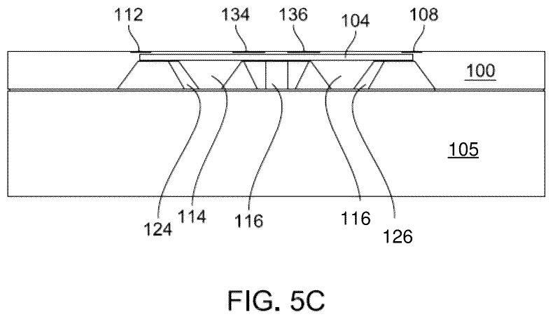

FIG. 5A is a diagrammatic view of a square silicon pressure sensor substrate in accordance with another embodiment of the present invention. Pressure sensor substrate 100 bears some similarities to pressure sensor 30, shown in FIG. 2, and like components are numbered similarly. Additionally, for illustration purposes, traces and conductors are not shown in FIG. 5A. Preferably, sensor 100 is configured to employ a Wheatstone bridge circuit where R1=R1a+R1b, R2=R2a+R2b, R3=R3a+R3b, and R4=R4a+R4b. Pressure sensor substrate 100 includes wafer 102 having a square deflectable diaphragm 104 formed in a central region of substrate 100. The deflectable diaphragm is generally formed by removing material, such as by etching, until a desired thickness is reached. A cover, such as cover 105 (shown in FIG. 5B) is then bonded or otherwise attached to substrate 100 complete manufacture of pressure sensor. The pressure sensor can be configured to be an absolute or gage pressure sensor depending on whether a vacuum is sealed within the pressure sensor or it is referenced to atmospheric pressure.

As shown in FIG. 5A, deflectable diaphragm 104 is square and thus has a number of maximum tensile strain locations 106, 108, 110, and 112 that are centered along edges of diaphragm 104. A tensile strain gauge R1a is located proximate location 112; R1b is located proximate location 106; R3a is located proximate location 108; and R3b is located proximate location 110. FIG. 5A also indicates the direction of strain sensitivity for each strain gauge location 106, 108, 110, 112, 130, 132, 134, and 136. Pressure sensor substrate 100 also includes a number of overpressure stops 114, 116, 118, 120, 122, 124, 126, and 128. These overpressure stops have a selected height above the surface of deflectable diaphragm that is configured to touch cover 105 during an overpressure condition in order to prevent further deflection of deflectable diaphragm 104. Overpressure stops 114 and 118 are disposed on opposite sides of the center of the deflectable diaphragm and are positioned in line with locations 112 and 108. Similarly, overpressure stops 116 and 120 are also disposed on opposite sides of the center of deflectable diaphragm 104 and are positioned in line with locations 106 and 110. If overpressure stops 114, 116, 118, and 120 can be considered to be at angular positions 0, 90, 180, and 270 degrees, then overpressure stops 122, 124, 126, and 128 can be considered to be at angular positions 45, 135, 225, and 315 degrees. Additionally, while overpressure stops 114, 116, 118, and 120 are disposed at a first distance from the center of diaphragm 104, overpressure stops 122, 124, 126, and 128 are positioned at a second distance from the center of deflectable diaphragm, where the second distance is greater than the first distance. In this arrangement, there are four locations 130, 132, 134, and 136 of maximum compressive strain. In the embodiment shown in FIG. 5A, strain gauge R2a is located proximate location 130; strain gauge R4b is located proximate location 132; strain gauge R4a is location proximate location 134; and strain gauge R2b is located proximate location 136.

FIG. 5C is a cross-sectional view of a silicon pressure sensor assembly in accordance with an embodiment of the present invention. Pressure sensor assembly is formed of cover 105 (shown in FIG. 5B) bonded to pressure sensor 100 (shown in FIG. 5A). As can be seen, overpressure stops 114, 116, 124, 126, and 128 extend from deflectable diaphragm 104 nearly to cover 105. The distance between the overpressure stops and cover 105 is selected such that contact occurs between the overpressure stops and cover 105 during an overpressure condition. As can also be seen, in a preferred embodiment, strain gauges disposed at locations 112, 134, 136, and 108 are disposed on an opposite side of deflectable diaphragm 104 than the overpressure stops.

Sensors designed for high pressure applications typically have a smaller, thicker diaphragm to support the higher pressures. The smaller diaphragms on these sensors make adding additional gages more difficult because there is not sufficient space on the diaphragm for the additional gages. In accordance with another embodiment of the present invention, the additional gages are placed on a second diaphragm to provide two pressure sensors with four gages each and an appropriate electrical connection for the gages.

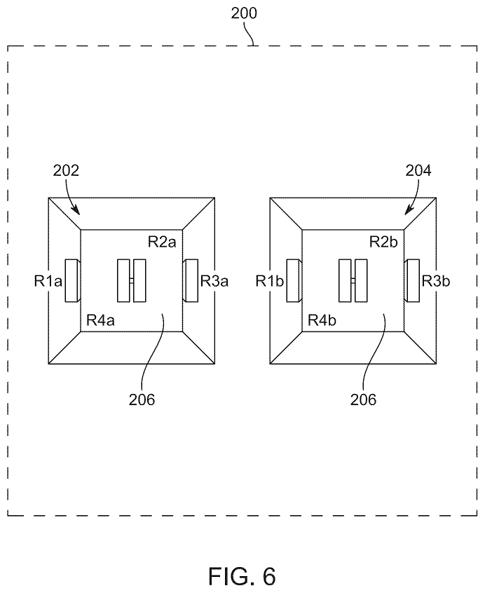

FIG. 6 is a diagrammatic view of a multi-sensor system in accordance with an embodiment of the present invention. As shown in FIG. 6, pressure sensing system 200 includes a plurality of pressure sensors 202, 204, where each pressure sensor 202, 204 includes a square deflectable diaphragm 206. Pressure sensor 202 includes a first strain gauge R1a located at a first edge of deflectable diaphragm 206 and a second strain gauge R3a located at a second edge of deflectable diaphragm 206 that is opposite strain gauge R1a. Sensor 202 also includes a pair of strain gauges R2a and R4a located in a central region of deflectable diaphragm 206. Pressure sensor 204 includes a first strain gauge R1b located at a first edge of deflectable diaphragm 206 and a second strain gauge R3b located at a second edge of deflectable diaphragm 206 that is opposite strain gauge R1b. Sensor 204 also includes a pair of strain gauges R2b and R4b located in a central region of deflectable diaphragm 206. These various strain gauges are preferably combined in a single Wheatstone bridge for sensing. With eight strain gages, R1a, R1b, R2a, R2b, R3a, R3b, R4a, and R4b, pressure sensing system 200 can employ two electrically separate Wheatstone bridges, forming a sensor with a basic level of redundancy.

The utilization of additional strain gauges provides a number of advantages. As set forth above, the additional strain gauges provide an increase in the gage factor of the sensor. Another advantage is that using additional strain gauges enables the utilization of a thicker deflectable diaphragm. In such instance, while embodiments described herein may have less or even no improvement on gage factor, the thicker diaphragm thicker diaphragm will improve the linearity and overpressure rating of the sensor.

Embodiments described herein are believed to provide pressure sensors that are superior to known designs in most of at least five sensor metrics including: Gage factor range; Minimum contact Pressure; Minimum overpressure; Nonlinearity; and Zero drift after 5 days. With respect to the gage factor range, a known pressure sensor has a gage factor range from 15-17.5 mV/V while a sensor in accordance with an embodiment of the present invention as a gage factor range from 17-20.4 mV/V. With respect to minimum contact pressure, the known sensor has a minimum contact pressure of 165 psi, while the improved sensor has a minimum contact pressure of 185 psi. With respect to minimum overpressure, the known sensor has a minimum overpressure rating of 10,000 psi, while the improved sensor has a minimum over pressure rating of 12,000 psi. With respect to nonlinearity, the known pressure sensor has a non-linearity of 0.946% span, while the improved sensor has a nonlinearity of 0.83% span. Finally, with respect to zero drift at 5 days, the known sensor has a zero drift of −0.0325%, while the improved sensor has a zero drift of −0.035%. Thus, the improved design has a higher gage factor, overpressure behavior, and more linear output. The only potential disadvantage is that the improved sensor has slightly more zero drift. This is believed to be due to die attach solder creep due to the sensor's higher output.

FIG. 7 is a block diagram of a pressure sensing system with which embodiments described herein are particularly useful. Transmitter electronics 400 includes controller 402, communication module 408, measurement circuitry 404 and power module 406. As shown in FIG. 7, measurement circuitry 404 is coupled to strain gauges on pressure sensor 410, which may be pressure sensor 50 (shown in FIG. 2), pressure sensor 100 (shown in FIG. 5a), or pressure sensing system 200 (shown in FIG. 6).

Controller 402 may be any suitable circuitry that is able to execute a number of programmatic steps or functions to communicate with an external device using communication module 408. Controller 402 may be an application specific integrated circuit (ASIC), field programmable gate array (FPGA), microcontroller, or microprocessor.

Communication module 408 is configured to interact with controller 402 to communicate in accordance with one or more standard protocols. The standard protocol may be a wired communication protocol, such as HART, 4-20 mA, FOUNDATION™ Fieldbus, Profibus, Modbus, Ethernet, and Ethernet-APL. The standard protocol may be a wireless communication protocol. Examples of wireless communication protocols include, without limitation, WirelessHART (IEC 62591), Cellular (NB-IoT, LTE-M), Wi-Fi, LoRaWAN, and Bluetooth Low Energy.

Transmitter electronics 400 also includes power management circuitry 406 and provides regulated power to components of transmitter electronics 400. For example, power management circuitry 406 can provide a suitable voltage source for voltage input 40 (shown in FIG. 3B).

As shown in FIG. 7, transmitter electronics 400 includes measurement circuitry 404 coupled to controller 402. Measurement circuitry 404 includes suitable circuitry for measuring an analog electrical characteristic (e.g., resistance) of one or more strain gauges on pressure sensor 410 and providing a digital indication of the measured analog electrical characteristic to controller 402. Suitable examples of circuitry of measurement processing circuitry includes one or more analog-to-digital converters, one or more amplifiers, and or one or more multiplexers or switches.

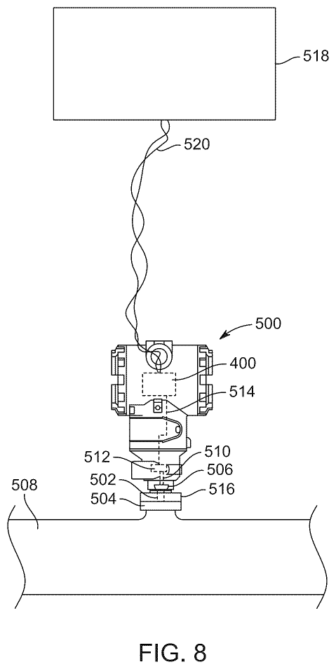

FIG. 8 is a diagrammatic view of a pressure sensing system with which embodiments described herein are particularly useful. In FIG. 8, a process variable transmitter 500 is mounted to a process coupling 504 of a pipe section 508 by a mounting member 516.

Mounting member 500 includes bore 502 which extends from process coupling 504 to an isolation diaphragm assembly 506. Isolation diaphragm assembly 506 includes an isolation diaphragm that isolates the process fluid in pipe section 508 from isolation fluid carried in an isolation capillary 510. Isolation capillary 510 couples to a pressure sensor 512, which takes the form of pressure sensor 100 described above. Pressure sensor 512 is configured to measure an absolute pressure (relative to vacuum) or a gage pressure (relative to atmospheric pressure) and provide an electrical output 514 to transmitter circuitry 400.

Transmitter circuitry 400 communicates with control room 518 to provide one or more process variables to control room 518, such as absolute pressure and gage pressure. Transmitter circuitry 400 may communicate with control room 518 using various techniques including both wired and wireless communication.

Although the present invention has been described with reference to preferred embodiments, workers skilled in the art will recognize that changes may be made in form and detail without departing from the spirit and scope of the invention. For example, embodiments described herein can be applied to other strain gage measurements where the strain of interest is at a point and several of the points are available to measure. Load cells for measuring force is one possible alternate application of embodiments described herein.

What is claimed is:

1. A pressure sensor comprising:
a crystalline substrate;
a deflectable diaphragm formed in the crystalline substrate; and
at least five strain gauges attached to the deflectable diaphragm each strain gauge having an electrical characteristic that varies with diaphragm deflection.

2. The pressure sensor of claim 1, wherein the deflectable diaphragm is square.

3. The pressure sensor of claim 1, wherein two of the at least five strain gauges are located proximate a center of the deflectable diaphragm.

4. The pressure sensor of claim 3, wherein four strain gauges of the at least five strain gauges are located proximate different edges of the deflectable diaphragm.

5. The pressure sensor of claim 4, wherein the four strain gauges located proximate different edges are centered on each respective edge of the deflectable diaphragm.

6. The pressure sensor of claim 5, wherein the four strain gauges located proximate different edges are located on regions of peak tensile strain.

7. The pressure sensor of claim 5, wherein a first plurality of strain gauges of the four strain gauges located proximate different edges are connected in series.

8. The pressure sensor of claim 7, wherein a second plurality of strain gauges of the four strain gauges located proximate different edges are also connected in series.

9. The pressure sensor of claim 8, wherein the four strain gauges located proximate different edges utilize a Wheatstone bridge circuit.

10. The pressure sensor of claim 9, wherein the two strain gauges located proximate the center of the deflectable diaphragm form opposite legs in the Wheatstone bridge circuit and the remaining two legs of the Wheatstone bridge circuit each consist of a plurality of edge strain gauges connected in series.

11. The pressure sensor of claims 10, wherein each of the four strain gages positioned proximate the different edges of the deflectable diaphragm have a resistance that is half of the resistance of the two strain gauges located proximate the center of the deflectable diaphragm.

12. The pressure sensor of claim 1, wherein the at least five strain gauges includes at least four strain gauges disposed on different edges of the deflectable diaphragm and at least two strain gauges disposed proximate a center of the deflectable diaphragm.

13. A pressure sensor comprising:
a crystalline substrate;
a deflectable diaphragm of non-uniform thickness formed in the crystalline substrate; and
at least eight strain gauges mounted to the square deflectable diaphragm and configured to measure the deflection of the deflectable diaphragm.

14. The pressure sensor of claim 13, wherein the deflectable diaphragm is square.

15. The pressure sensor of claim 14, wherein four of the at least eight strain gauges are positioned on points of maximum compressive strain, and another four strain gauges of the eight strain gauges are positioned on points of maximum tensile strain.

16. The pressure sensor of claim 15, wherein pairs of strain gages located on points of maximum strain are connected in series.

17. The pressure sensor of claim 16, wherein the strain gauges are arranged in a Wheatstone bridge circuit where the four strain gages located at points of maximum compressive strain form two opposite legs of the bridge, with two strain gauges connected in series in each leg of the bridge.

18. The pressure sensor of claim 17, wherein the four strain gauges located at points of maximum tensile strain form two opposite legs of the bridge, with two gauges connected in series in each leg of the bridge.

19. A pressure sensor system comprising:
a first pressure sensor having a square deflectable diaphragm and at least four strain gauges disposed thereon;
a second pressure sensor having a square deflectable diaphragm and at least four strain gauges disposed thereon; and
wherein the strain gages from the first and second pressure sensor form a single Wheatstone bridge to increase an electrical signal from the pressure sensor system.

20. The pressure sensor system of claim 19, wherein all strain gages have the same nominal resistance.

21. The pressure sensor system of claim 19, wherein the pressure sensor system is manufactured using MEMS technology.
